(19) United States
(12) Patent Application Publication
(10) Pub. No.: US 2025/0002103 A1
(43) Pub. Date: Jan. 2, 2025

(54) SKID PLATE FOR MOTORCYCLE SADDLE BAG

(71) Applicant: SIOUXICIDE CHOPPERS, INC., SIOUX CITY, IA (US)

(72) Inventor: DANA MENEFEE, SIOUX CITY, IA (US)

(21) Appl. No.: 18/758,404

(22) Filed: Jun. 28, 2024

Related U.S. Application Data
(60) Provisional application No. 63/511,249, filed on Jun. 30, 2023.

(51) Int. Cl. B62J 7/02

(52) U.S. Cl. CPC B62J 7/02

(57) ABSTRACT

To better protect motorcycles and other vehicles, such as two-wheeled vehicles, from damage due to tipping or falling, a strategically placed skid plate can be utilized. The skid plat can be positioned relative to low level positions of the vehicles, such as near pipes, footrests, saddlebags, or the like. The skid plates will provide a layer of protection to mitigate the components of the vehicle from excess damage, including paint chipping, denting, cracking, or the like. The skid plates can also be used to mitigate or even prevent the vehicles from fully tipping on their side, which mitigates even more damage to the vehicle.

### CROSS-REFERENCE TO RELATED APPLICATIONS

This application claims priority to U.S. Provisional Patent Application Ser. No. 63/511,249 filed Jun. 30, 2023 and hereby incorporates by reference the same in its entirety.

### TECHNICAL FIELD

The present disclosure relates generally to an apparatus having applications in at least the motorcycle industry. More particularly, but not exclusively, the present disclosure relates to a skid plate used in conjunction with saddle bags and/or other portions of a motorcycle to protect the portions from damage.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Motorcycles come in a number of styles and can be customized in a number of ways. For example, some motorcycles may be fitted with saddlebags, which are otherwise referred to as panniers. On a motorcycle, modern panniers are normally hard-shell cases mounted behind the seat and on either side of the rear wheel, attached to a framework (which bolts to the motorcycle frame) known as a carrier. Modern panniers are made to be quickly detachable. As noted, motorcycle panniers are generally hard box containers with lids, made of metal or hard plastic. The panniers may be permanently fixed to the motorcycle or may be removable. Soft cases may be leather or fabric, usually without permanent mountings, and are often called saddlebags or ‘throwovers’.

The saddlebags or panniers are generally painted similar to the paint job for the other components of the motorcycle, such as the fenders, gas tanks, seats, or handlebars. The painting of the components is often customizable and created for a particular customer.

Still further, many of the components of a motorcycle can be customized or otherwise designed per a customer/rider. This can include variations to handlebars, seats, fenders, footrests, and especially exhaust pipes. The exhaust pipes can be sized, shaped, painted, or otherwise customized per a rider's choice. This often includes having the exhaust extend beyond the rear of the motorcycle and at a low point.

As exhaust pipes and saddlebags often are at a low point of the motorcycle, they can be prone to damage. If a motorcycle were to tip sideways, the exhaust pipes and/or saddlebags are often the first portions to the motorcycle to contact the ground. Such contact can cause damage, which can include, but is not limited to paint chipping, scratching, denting, cracking, or the like. Likewise, if there is an obstruction extending upward from a surface, these components are the most likely to contact said obstruction, resulting in similar damage. This can result in the decision between expensive repair or leaving as is and being reminded of the damage.

Thus, there exists a need in the art for an apparatus which provides at least some protection for motorcycles, especially on the occasion that a motorcycle were to tip sideways or to pass an obstruction.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of any of the aspects and/or embodiments of the present disclosure protect one or more components of a motorcycle. For example, the apparatus disclosed herein may protect saddlebags, pipes, footrests, or other components.

It is still yet a further object, feature, and/or advantage of any of the aspects and/or embodiments of the present disclosure to mitigate a motorcycle from falling on its side.

The apparatus disclosed herein can be used in a wide variety of applications. For example, while the disclosure refers to motorcycles, it should be appreciated that the apparatus as included can be used in any number of vehicles, powered or not, that have a tendency or possibility of tipping on its side.

It is preferred the apparatus be safe, cost effective, and durable. For example, the apparatus can be adapted to resist mechanical failures (e.g., cracking, crumbling, shearing, creeping) due to excessive impacts and/or prolonged exposure to tensile and/or compressive forces acting on the apparatus.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the apparatus.

Methods can be practiced which facilitate use, manufacture, assembly, maintenance, and repair of an apparatus which accomplish some or all of the previously stated objectives.

The apparatus can be incorporated into systems or kits which accomplish some or all of the previously stated objectives.

According to some aspects of the present disclosure, a motorcycle, comprises a frame with a front wheel and a rear wheel defining a vertical plane orthogonal to ground when the front wheel is parallel with the rear wheel and the motorcycle is perpendicular to a ground; a seat positioned atop the frame; and a skid plate positioned adjacent to the rear wheel, said skid plate connected to the motorcycle with a skid portion extending outwardly from the vertical plane and extending further from said vertical plane than any rear component of the motorcycle when the motorcycle stands perpendicular to the ground in the vertical plane.

According to at least some aspects of some embodiments the skid plate includes a load-distributing cutout pattern.

According to at least some aspects of some embodiments the skid plate includes an attachment portion including a tab and an aperture.

According to at least some aspects of some embodiments the motorcycle further comprises an exhaust pipe operatively connected to the frame and outside of the rear wheel.

According to at least some aspects of some embodiments the skid plate includes an intermediate portion disposed between the skid portion and the attachment portion.

According to at least some aspects of some embodiments the intermediate portion is curved such that the intermediate portion may alternatively go around an exhaust pipe for the attachment portion to connect to the frame, or for the attachment portion to connect to the exhaust pipe such that the skid portion extends from the motorcycle at an angle that is substantially non-perpendicular to the vertical plane when the motorcycle stands perpendicular to the ground in the vertical plane.

According to at least some aspects of some embodiments the intermediate portion is a flat portion and a continuous extension of the skid portion, such that an entirety of the skid plate is flat.

According to at least some aspects of some embodiments the intermediate portion further includes an angled portion in addition to the flat portion such that the skid plate extends the skid portion at an angle non-parallel with the attachment portion.

According to at least some aspects of some embodiments the motorcycle further comprises a saddlebag attached to the frame adjacent the rear wheel, wherein the skid plate is attached to the saddlebag and the skid portion extends outwardly from both the saddlebag and the motorcycle.

According to at least some aspects of some embodiments the load-distributing cutout pattern includes an “X”.

According to at least some aspects of some embodiments the load-distributing cutout pattern includes a series of parallel slots.

According to at least some aspects of some embodiments the load-distributing cutout pattern includes a grid pattern.

According to yet other aspects of the present disclosure, a skid plate, comprising an attachment portion for attaching to a motorcycle; an intermediate portion extending from the attachment portion; a skid portion extending to a distal edge from the attachment portion; wherein attaching the skid plate to either of a frame or of an exhaust pipe of the motorcycle would result in the distal edge of the skid portion contacting a ground or foreign obstruction before other components of the motorcycle when the motorcycle tips toward a side that the skid plate is attached.

According to at least some aspects of some embodiments the skid plate includes a load-distributing cutout pattern.

According to at least some aspects of some embodiments the intermediate portion extends parallel from the attachment portion.

According to at least some aspects of some embodiments the intermediate portion comprises an angled portion such that the skid portion extends at an angle other than parallel from the attachment portion.

According to at least some aspects of some embodiments, the load-distributing cutout pattern includes an “X”.

According to at least some aspects of some embodiments the intermediate portion comprises a curved portion such that the skid plate may attach to a frame of the motorcycle while the intermediate portion curves around an exhaust pipe.

According to at least some aspects of some embodiments the attachment portion includes two tabs each with an aperture.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a depiction of a motorcycle.

FIG. 2 is a photograph showing a close-up view of a saddlebag on a motorcycle and including a skid plate according to aspects of the present disclosure.

FIG. 3 is a perspective view of a skid plate according to some aspects of some embodiments of the present disclosure.

FIG. 4 is a view similar to FIG. 3, but with the skid plate having an opposite orientation.

FIG. 5 is another photograph of a portion of a motorcycle showing a skid plate attached to an exhaust pipe of the motorcycle.

FIG. 6 is a close up photograph of the skid plate on the motorcycle of FIG. 5.

FIG. 7 shows left and right oriented skid plates according to still additional aspects and/or embodiments of the disclosure.

FIG. 8 is a photograph showing a skid plate of FIG. 7 attached to an exhaust pipe of a motorcycle.

FIG. 9 shows left and right oriented skid plates according to still additional aspects and/or embodiments of the disclosure.

An artisan of ordinary skill in the art need not view, within isolated figure(s), the near infinite distinct combinations of features described in the following detailed description to facilitate an understanding of the present disclosure.

### DETAILED DESCRIPTION

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

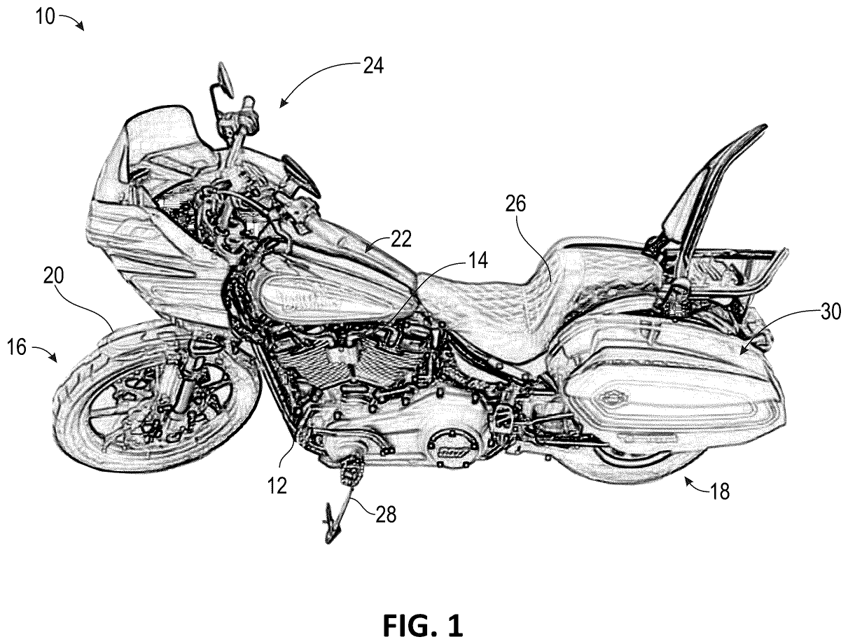

Motorcycles, such as the one shown in FIG. 1, include some common components, and some components that are more customizable. For example, each of the motorcycles shown in the figures, including the motorcycle 10 in FIG. 1, includes generally a frame 12, an engine 14, a front wheel as part of a front wheel/steering assembly that is connected to the frame in manner to allow rotational movement of the wheel, such as via handlebars 24, a rear wheel 18 mounted to the frame, a gas tank 22, and a seat 26. The seat 26 can be a single seat for one person or can include portions for multiple people. For example, the seat 26 in FIG. 1 includes a passenger seat behind the driver's seat, and also includes a backrest for the passenger.

Still additional components on most motorcycles include a front fender 20, a rear fender 21, a kickstand 28, and an exhaust pipe 32. The fenders are found on most motorcycles but may take different configurations. Likewise, most motorcycles will have a kickstand 28. The kickstand 28 is a device that allows the two-wheeled motorcycle 10 to be propped up in a manner to mitigate tipping when there is no rider on the motorcycle. Tipping generally refers to sideways falling of a motorcycle due to the wheels being aligned in a fore and aft manner, lacking any inherent stability as there is nothing to hold the bike from rotating out of a vertical plane. The kickstand 28 is rotatable from a first position that aligns substantially parallel with a direction of travel of the motorcycle, and a second position that is substantially orthogonal from a center of gravity of the motorcycle, a distal end of the kickstand 28 contacting the ground to allow the motorcycle 10 to lean one way, but to mitigate it from falling.

Also shown in some of the figures, including FIG. 1, are saddlebags 30. On a motorcycle, saddlebags 30 are normally hard-shell cases mounted adjacent to or behind the seat 26 and on either side of the rear wheel 18, attached to a framework (which bolts to the motorcycle frame) known as a carrier.

Many of the components of the motorcycle as described, such as the gas tank 22, fenders 20/21, and saddlebag 30, are generally painted. The components may have a common paint scheme, which provides customization for the motorcycle 10. The painting of the components allows the owner to easily identify their motorcycle and also to show pride in their motorcycle.

However, as mentioned, because most motorcycles are two-wheeled vehicles, there is nothing inherently keeping them upright. If there is no rider with feet on the ground to hold the motorcycle 10 upright, or if the kickstand 28 is not extended or otherwise fails, the motorcycle can tip over. In addition, because of the placement of the saddlebags 30 (low and rear), it is not uncommon for the saddlebags 30 to contact obstructions, curbs, or be the first component to contact the ground if the motorcycle 10 does tip over (even a slight tip over and not a full tip over, such that the saddlebag 30 is disposed over a curb and the rider leans to one side). This is undesirable and can lead to damaging the motorcycle 10, including damage to the components of paint thereon.

Therefore, aspects of the present disclosure relate to an apparatus for mitigating damage to the components of the motorcycle 10, such as if it were to tip over, ride adjacent to an obstruction on the ground, or run into a curb (such as during backing up of the motorcycle).

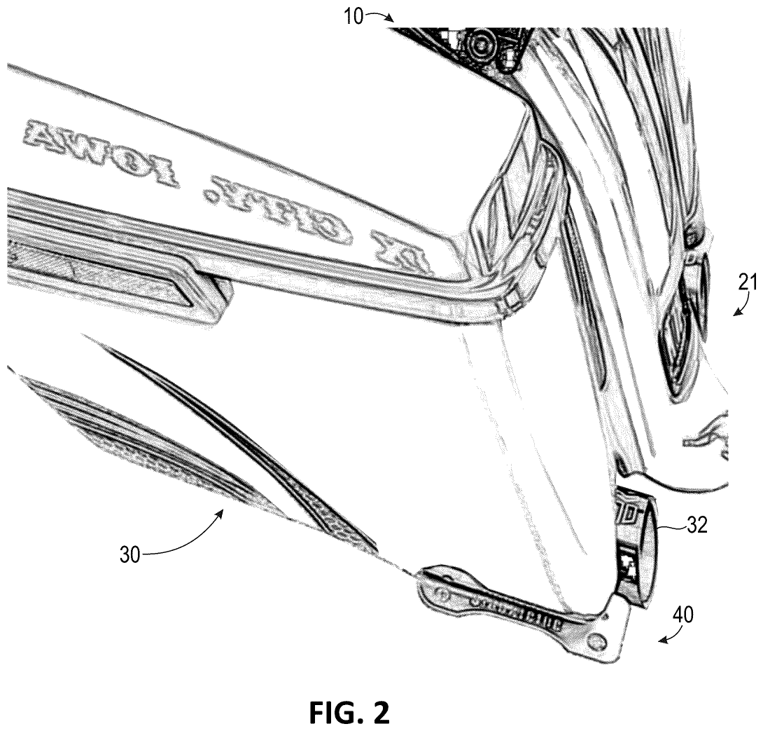

As shown in FIG. 2, a skid plate 40 can be operatively positioned relative to components, in this case the saddlebags 30 and exhaust pipe 32, of the motorcycle 10 in order to provide a layer of protection and to mitigate damage to the motorcycle if it were to tip over or otherwise contact an obstruction. The skid plate 40 in FIG. 2 is positioned generally below the saddlebag 30. It includes a portion, which will be referred to as the skid portion 42, that extends outwardly from the motorcycle 10 further than an outer edge of the saddlebag 30. Specifically, it is intended that a distal edge 43 come in contact with a ground or an obstruction before other components of the motorcycle such at the saddlebags 30, the exhaust pipe 32, the rear fender 21, or other painted portions of the motorcycle. The skid portion 42 may further include a design 44 and further a load-distributing cutout pattern 45 disposed thereon. It should be noted that a skid plate 40 can be positioned on both sides of the motorcycle 10 and extend outwardly in both directions.

The location of the skid plate 40, being below and outwardly extending of the saddlebags 30, provide a layer of protection for the saddlebags 30 and/or the exhaust pipe 32. If the motorcycle is moving and experiences an obstruction, the impact will contact the skid plate 40 and not the saddlebag 30 or exhaust pipe 32, thus protecting the same. In addition, should the motorcycle 10 tip over, the distal edge 43 of the skid plate 40 would contact the ground first, again mitigating any damage to the saddlebag 30, exhaust pipe 32, or other portions of the motorcycle 10.

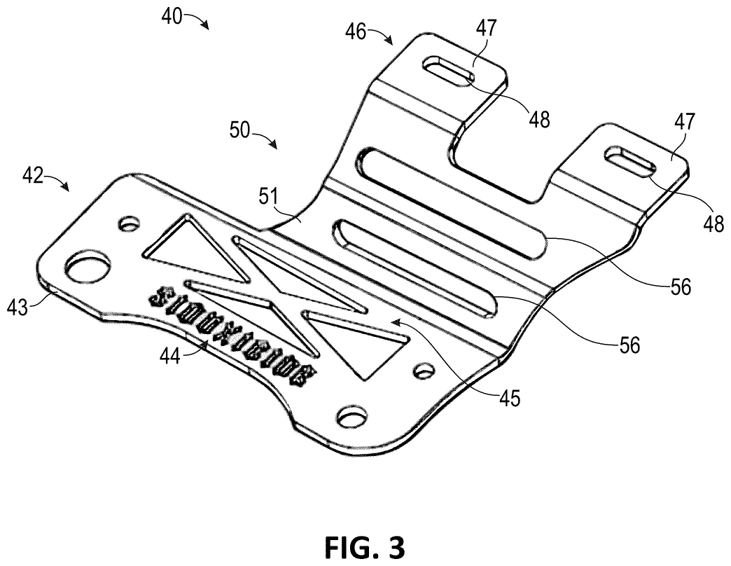

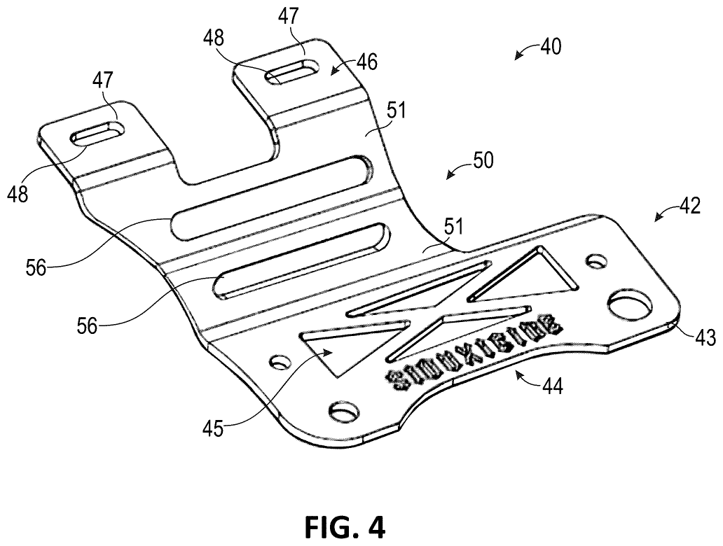

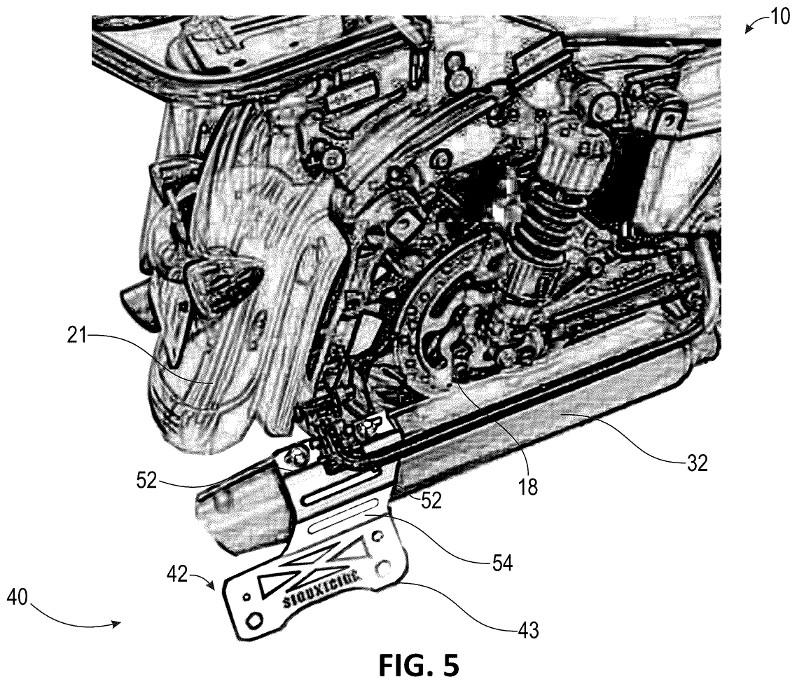

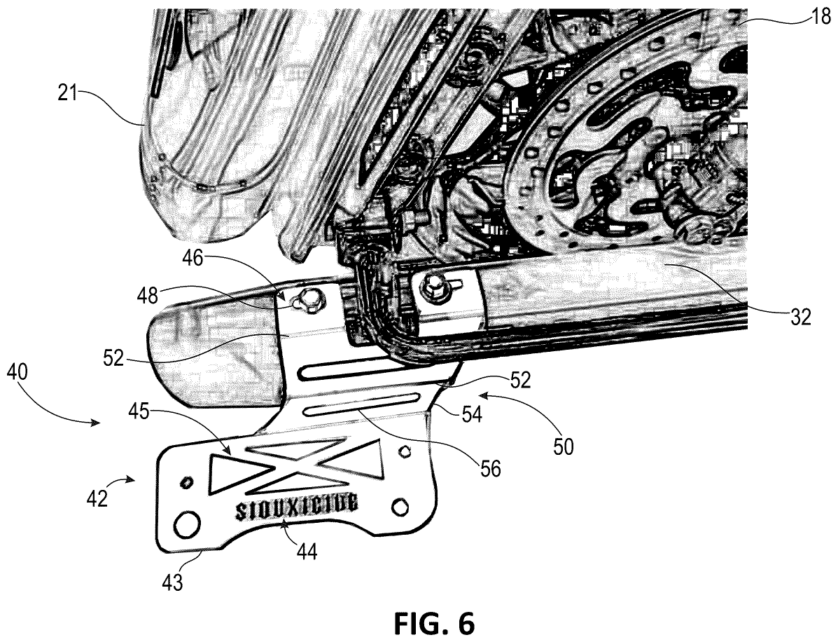

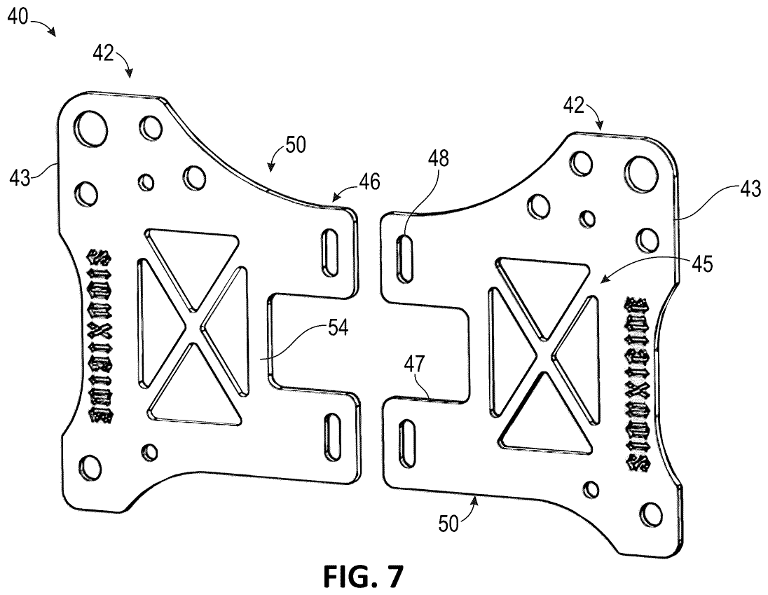

An example of a skid plate 40, such as shown attached to the motorcycle 10 in FIG. 2, is provided in FIGS. 3 and 4, which are left hand and right hand oriented. The orientation refers to the sides of the motorcycle 10 as indicated from a direction of travel. The skid plate 40 includes the skid portion 42, an attachment portion 46, and an intermediate portion 50. The skid portion 42 may include the distal edge 43, the design 44, and the load-distributing cutout pattern 45. The attachment portion 46 may include a tab 47, and an aperture 48. As understood by those of ordinary skill in the art, the attachment portion 46 may include a plurality of tabs 47 and a plurality of apertures 48. Further, the intermediate portion 50 may include a curved portion 51 as shown in FIGS. 3-4, an angled portion 52 as shown in FIGS. 5-6, or a flat portion 54 as shown in FIGS. 7-9. Each of which will be discussed herein. The intermediate portion 50 may further include weight-reduction slots 56 as shown in FIGS. 3-6. The skid plate 40 comprises a metal (e.g., steel) material or other rigid material to withstand contact with an obstruction, a curb, or the ground.

The skid portion 42 can take many shapes, sizes, and/or configurations, depending on the motorcycle 10, the saddlebags 30, additional components of the motorcycle, or some combination thereof. However, it should be noted that that the skid portion 42 will extend further than the saddlebag 30 to provide protection thereto. Namely, should the motorcycle 10 stand perfectly straight up and be in perfect alignment with the vertical plane wherein the wheels are aligned parallel to the vertical plane, the skid portion 42, and specifically the distal edge 43 would be the furthest distal portion orthogonal to the vertical plane with respect to a lower half of the motorcycle's 10 center of gravity. This is not to say that the skid portion 42 can only be orthogonal to said vertical plane when the motorcycle and wheels are aligned parallel with the vertical plane. The skid portion 42 can protrude at an angle as described herein, and in a preferred embodiment the distal edge 43 may still be the furthest distal portion orthogonal to the vertical plane with respect to the lower half of the motorcycle's 10 center of gravity even at an angle other than orthogonal to the vertical plane so as to be a first point of contact with the ground when the motorcycle 10 tips over. As understood by those of ordinary skill in the art, this does not mean that the skid plate 40 is the longest or widest component of the motorcycle as the skid plate 40 does not need to connect directly to the frame 12. In such examples the skid plate 40 may attach to a component further out than the frame 12 such as the exhaust pipe 32 such that the distal edge 43 is the furthest distal portion orthogonal to the vertical plane with respect to the lower half of the motorcycle's 10 center of gravity when the motorcycle is standing straight up parallel to the vertical plane.

As shown in FIGS. 3 and 4, the skid portion 42 includes the design or logo 44 therethrough, which can be used as a source identifier for the motorcycle 10 or skid plate 40. The logo/design 44 allows for additional customization for the motorcycle 10.

The skid portion may include the load-distributing cutout pattern 45. The load-distributing cutout pattern 45 provides at least three benefits. A first benefits includes reducing weight of the skid plate 40. This improves variability in where the skid plate 40 can connect to (i.e., attaching a 20-lbs hunk of metal to a distal end of an exhaust pipe not designed to permanently uphold additional weight could impair a structural integrity of an exhaust system by creating a moment or torque on the exhaust pipe perpetually that would be exacerbated every time the motorcycle 10 went over a bump, whereas a lighter-weight and permanently attached-to the distal end of the exhaust pipe skid plate 40, on the order of 2-to-10-lbs, would significantly improve the operational duration of the exhaust system in comparison to the 20-lbs skid plate 40). Thus, while the skid portion 42 need not include a load-distributing cutout pattern to reduce weight (and in some situations may not be desirable, such when the skid plate 40 is desired to be as bulky and strong as possible), while it need not be included, including the load-distributing cutout pattern 45 can provide variability and versatility in where the skid plate attaches to—not only “where” in reference to where on the motorcycle 10 the skid plate 40 attaches, but also “where” in reference to the types of motorcycles that the skid plate 40 may attach to.

A second benefit of the load-distributing cutout pattern 45 is to reduce cost. The skid plate 40 often comprises a durable, metal material and it can be beneficial to reduce an amount of material on the skid plate 40 by including the load-distributing cutout pattern 45.

A third benefit of the load-distributing cutout pattern 45 is that while providing benefits one and two described above, the load-distributing cutout pattern 45 retains a greater degree of structural stability than randomly-placed weight-reducing apertures. It is the same concept as of that used in bridge building, wherein a structure beneath a bridge includes a load-distributing pattern of (among other options) a cross-bracing configuration, an “X” pattern reinforcement, a triangular truss system, a lattice girder structure, or a diagonal bracing design. In this regard, an area beneath the bridge need not comprise thousands of tons of bulk material (such as a huge mound of dirt) to uphold the bridge, which would effectively remove travelability under the bridge. Rather, an area beneath the bridge maintains structural integrity by including said load-distributing patterns rather than requiring the huge mound of dirt to uphold the bridge.

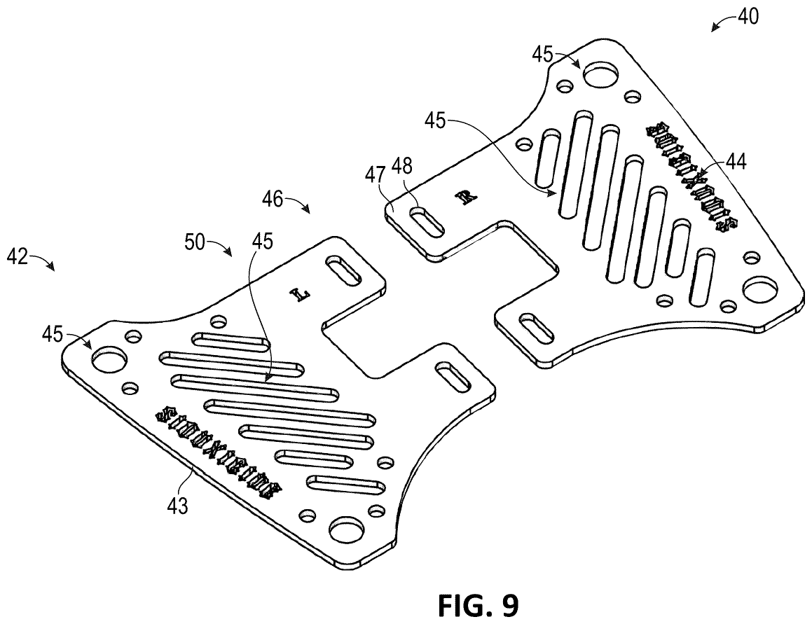

The load-distributing cutout pattern of the present disclosure serves a significant purpose in the same regard as the load-distributing patterns used for bridges. However, rather than upholding a weight of a bridge, the skid plate 40 is designed to withstand impact from foreign objects such as a curb, passing-objects while riding the motorcycle 10, or the pavement, should the motorcycle 10 tip. Retaining structural integrity of the skid plate 40 improves a likelihood of preserving other rear components of the motorcycle such as the saddlebags 30, the rear fender 21, or other customized or painted portions of the motorcycle at the rear. As such, the load-distributing cutout pattern 45 may include an “X” as shown in FIGS. 3-8, a series of parallel slots as shown in FIG. 9, a plurality of diagonally placed circles as shown in FIG. 9, a grid-pattern, a pattern including a series of triangles, an alternating slot and circle pattern, among others. The load-distributing cutout pattern 45 may further include a lattice-structure such as a beam lattice, a TPMS lattice (gyroid), a honeycomb lattice, or a stochastic lattice (Voronoi) each used in additive manufacturing. However, as explained above, the skid plate 40 need not include the load-distributing cutout pattern 45 as sheer bulk may be a desired attribute of the skid plate 40 to be used.

Opposite the skid portion 42 is the attachment portion 46. The attachment portion 46 is the part of the skid plate 40 that will attach to a portion of the motorcycle 10. For example, the skid plate 40 shown in FIGS. 3 and 4 is also shown attached to a motorcycle 10 in FIG. 2. The attachment portion 46 of FIGS. 3-4 includes the plurality of tabs 47 and the plurality of apertures 48 to facilitate connection to the frame 12 of the motorcycle 10, the exhaust pipe 32, or the saddlebags 30. Should the tab 47 be a single tab 47 it will in all likelihood simply look like an extension of the intermediate portion 50, not having any cut-outs for separation of multiple tabs as opposed to the plurality of tabs 47 shown in FIGS. 3-4 having a cutout between them. Should the attachment portion 46 be a single tab 47 it may include a single aperture 48 shaped as a slot configured to accommodate a plurality of screws, nuts/bolts, etc., or alternatively may be the single tab 47 including the plurality of apertures 48 so as to accommodate the plurality of screws, nuts/bolts, etc. However, as understood by those of ordinary skill in the art, although the attachment portion 46 is shown to include the tab 47 and the aperture 48, the attachment portion 46 may be configured to accommodate screws, nuts, bolts, pins, rivets, staples, washers, grommets, latches (including pawls), ratchets, clamps, clasps, flanges, ties, adhesives, welds, any other known fastening mechanisms, or any combination thereof to facilitate attaching, fastening and/or connection of the skid plate 40 to the motorcycle 10. By way of example and not of limitation the tab 47 may comprise a sliding connection to slidingly attach to a rail. Such features including the exact type of fastening is not limiting unless expressly claimed.

Although FIGS. 3-4 show one example of the intermediate portion 50, there are multiple different kinds of intermediate portions 50 possible as shown by different intermediate portions 50 as shown in FIGS. 5-6 and 7 and 9. It is further noted that the motorcycle 10 includes an exhaust pipe 32 adjacent the saddlebag 30. Therefore, the skid plate 40 shown in FIGS. 3-4 includes an intermediate portion 50 that comprises a curved portion 51 between the skid portion 42 and the attachment portion 46. The curved portion 51 is configured to be positioned under the exhaust pipe 32 and thus will have curvature similar to said pipe. As understood by those of ordinary skill in the art, the intermediate portion 50 may comprise an angled portion 52 as shown in FIGS. 5-6. The example shown in FIGS. 5-6 includes three angled portions 52 to be exact, including two flat portions 54 in between. This is in contrast to the examples shown in FIGS. 7 and 9 wherein no angled portions 52 or curved portions 51 are included, rather a single flat portion 54 is included. The intermediate portion 50 serves as a junction between the attachment portion 46 and the skid portion 42. Thus, the skid plate 40 may generally include an attachment portion 46 with an intermediate portion 50 extending therefrom, and a skid portion 42 extending from an end of the intermediate portion 50 opposite the attachment portion 46. Whether the intermediate portion 50 includes only the flat portion 54, or instead includes a single flat portion 54 in combination with a single angled portion 52, or instead includes a single flat portion 54 in combination with two angled portions 52, or instead includes a curved portion 51, or instead includes any combination thereof, such features are non-limiting unless expressly claimed, as the intermediate portion 50 may be configured in multiple ways so as to fit the needs of varying motorcycle shapes and styles. As understood by those of ordinary skill in the art, multiple configurations of the intermediate portion 50 are possible.

FIG. 5 shows another version of a motorcycle 10 with a skid plate 40. The motorcycle 10 of FIG. 5 shows no saddlebag 30. The saddlebag 30 is not needed in all embodiments. However, the saddlebag 30 may be removed to show how the skid plate 40 is attached for this configuration as well. A closer view of the skid plate 40 is shown in FIG. 6. As shown, the skid plate 40 in FIGS. 5 and 6 is connected to the exhaust pipe 32. The skid plate 40 includes the skid portion 42 and the attachment portion 46 but has a differently shaped intermediate portion 50. While the configuration in FIGS. 3-4 showed a generally U-shaped intermediate section of the skid plate configured to go under the exhaust pipe 32, in FIG. 6 although the combination of multiple angled portions 52 and flat portions 54 could allow for going around the exhaust pipe 32, the example shown in FIGS. 5-6 has the attachment portion 46 attached directly onto the exhaust pipe 32 and is angled downward. This allows the distal edge 43 of the skid portion 42 to be positioned at a lower level, while still providing protection. This shows that the skid plate 40, including portions thereof, can take many forms and may be more dependent on the motorcycle and/or components thereof.

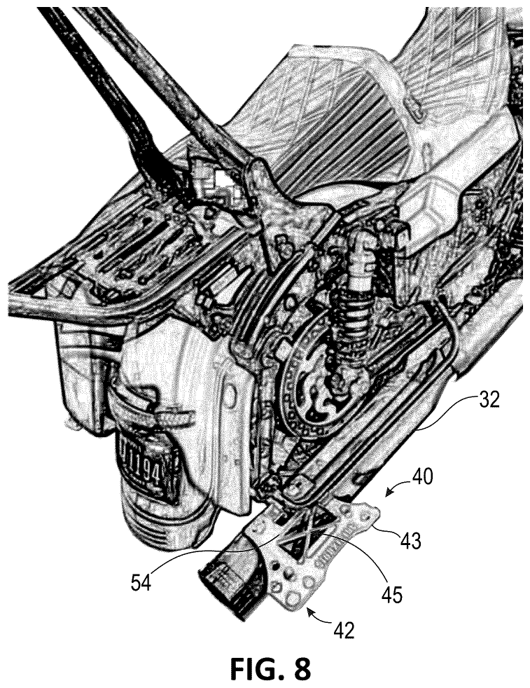

For example, FIG. 8-9 show yet additional variations to the skid plate 40, including showing it connected to a motorcycle 10. In these figures, the skid plate 40, including the skid portion 42, the intermediate portion 50, and the attachment portion 46, are all generally planar with one another, forming a generally flat skid plate. As such, the intermediate portion 50 includes no angled portions 52 or curved portions 51, only the flat portion 54. As shown, the skid plate may have the design 44 to allow customization/identification.

As shown in FIG. 8, the generally flat skid plate 40 is again connected to the exhaust pipe 32. The saddlebag 30 has been removed in this figure. However, it should be noted that the skid plate 40 would extend outwardly beyond the outer periphery of the saddlebag 30 to provide the protection from contact as has been shown and described herein.

FIG. 9 shows the skid plate 40 like that of FIGS. 7-8, wherein the skid plate 40 is a flat and continuous extension of the attachment portion 46, to the intermediate portion 50, to the skid portion 42. As shown in FIG. 9, the skid plate 40 may include a combination of load-distributing cutout patterns 45. The skid plate 40 may further include this combination in addition to the design 44. Also readily apparent from the examples in FIGS. 7 and 9 is that a combination of left and right skid plates 40 may be symmetrical with respect to one another.

As understood by those of ordinary skill in the art, the different examples of the skid plate 40 shown herein include combining the attachment portion 46, the intermediate portion 50, and the skid portion 42 and differing variations of each such that the skid plate 40 meets the requirements for a given user. One user may desire the skid plate 40 to look exactly like the skid plate 40 shown in FIG. 9. Another user may desire the skid plate 40 to look like the example shown in FIG. 9 except with an extended intermediate portion 50 to connect directly to the frame 12 of the motorcycle and further that the intermediate portion 50 may comprise a curved portion 51 to go around the exhaust pipe 32, and further comprise an angled portion 52 so as to cause the skid plate 40 to tilt at a downward angle like that show in FIGS. 5-6 rather than to extend substantially perpendicular from the motorcycle 10 such as with the example shown in FIG. 2.

Therefore, it will be appreciated that the skid plate 40 is not a one-size-fits-all configuration, and that many different sizes, shapes, etc. should be contemplated for varying motorcycle types and designs. The skid plates according to the present disclosure may take on any known three-dimensional shape. For example, the shape of the skid plate 40 may be selected from the group consisting of cylinders, ellipsoids (including spheres), partial ellipsoids (including hemispheres), regular polyhedrons (including pyramids, cubes, etc.), irregular polyhedrons, cones, surfaces of revolution (including tori), helixes (e.g., coils and springs), and a combination thereof.

The surfaces of the skid plates may take on any known two-dimensional shape. For example, the shape of the surfaces of the skid plates may be selected from the group consisting of ovals (including ellipses, circles, etc.), partial ellipses (including semicircles), stadiums, regular polygons (including triangles, rectangles, etc.), complex polygons (including cruciforms, stars), irregular polygons, cones, and combinations thereof.

The skid plates 40 may comprise any one or a combination of any known rigid materials, such as metals and metallic alloys, steel, plastics, composites, wood, stone, glass, and synthetic materials imitating the properties of any of the preceding materials.

Therefore, it should be appreciated that the skid plates as shown and described provide numerous benefits and advantages. The positioning of the plates will provide needed protection for the components of the motorcycle, including the saddlebags and/or exhaust pipes.

1. A motorcycle, comprising:
a frame with a front wheel and a rear wheel defining a vertical plane orthogonal to ground when the front wheel is parallel with the rear wheel and the motorcycle is perpendicular to a ground;
a seat positioned atop the frame; and
a skid plate positioned adjacent to the rear wheel, said skid plate connected to the motorcycle with a skid portion extending outwardly from the vertical plane and extending further from said vertical plane than any rear component of the motorcycle when the motorcycle stands perpendicular to the ground in the vertical plane.

2. The motorcycle of claim 1, wherein the skid plate includes a load-distributing cutout pattern.

3. The motorcycle of claim 2, wherein the skid plate includes an attachment portion including a tab and an aperture.

4. The motorcycle of claim 3, further comprising an exhaust pipe operatively connected to the frame and outside of the rear wheel.

5. The motorcycle of claim 4, wherein the skid plate includes an intermediate portion disposed between the skid portion and the attachment portion.

6. The motorcycle of claim 5, wherein the intermediate portion is curved such that the intermediate portion may alternatively go around an exhaust pipe for the attachment portion to connect to the frame, or for the attachment portion to connect to the exhaust pipe such that the skid portion extends from the motorcycle at an angle that is substantially non-perpendicular to the vertical plane when the motorcycle stands perpendicular to the ground in the vertical plane.

7. The motorcycle of claim 5, wherein the intermediate portion is a flat portion and a continuous extension of the skid portion, such that an entirety of the skid plate is flat.

8. The motorcycle of claim 7, wherein the intermediate portion further includes an angled portion in addition to the flat portion such that the skid plate extends the skid portion at an angle non-parallel with the attachment portion.

9. The motorcycle of claim 7, further comprising a saddlebag attached to the frame adjacent the rear wheel, wherein the skid plate is attached to the saddlebag and the skid portion extends outwardly from both the saddlebag and the motorcycle.

10. The motorcycle of claim 9, wherein the load-distributing cutout pattern includes an “X”.

11. The motorcycle of claim 2, wherein the load-distributing cutout pattern includes an “X”.

12. The motorcycle of claim 2, wherein the load-distributing cutout pattern includes a series of parallel slots.

13. The motorcycle of claim 2, wherein the load-distributing cutout pattern includes a grid pattern.

14. A skid plate, comprising:
an attachment portion for attaching to a motorcycle;
an intermediate portion extending from the attachment portion;
a skid portion extending to a distal edge from the attachment portion;
wherein attaching the skid plate to either of a frame or of an exhaust pipe of the motorcycle would result in the distal edge of the skid portion contacting a ground or foreign obstruction before other components of the motorcycle when the motorcycle tips toward a side that the skid plate is attached.

15. The skid plate of claim 14, wherein the skid plate includes a load-distributing cutout pattern.

16. The skid plate of claim 14, wherein the intermediate portion extends parallel from the attachment portion.

17. The skid plate of claim 14, wherein the intermediate portion comprises an angled portion such that the skid portion extends at an angle other than parallel from the attachment portion.

18. The skid plate of claim 16, wherein the load-distributing cutout pattern includes an “X”.

19. The skid plate of claim 15, wherein the intermediate portion comprises a curved portion such that the skid plate may attach to a frame of the motorcycle while the intermediate portion curves around an exhaust pipe.

20. The skid plate of claim 19, wherein the attachment portion includes two tabs each with an aperture.
